(19) United States
(12) Patent Application Publication
(10) Pub. No.: US 2025/0181386 A1
(43) Pub. Date: Jun. 5, 2025

(54) TASK PRIORITY CONTROL FOR NETWORK RESOURCES

(71) Applicant: RAKUTEN MOBILE, INC., Tokyo (JP)

(72) Inventors: Jun OKADA, Tokyo (JP); Rion KIMURA, Tokyo (JP); Hiroyuki JO, Tokyo (JP)

(21) Appl. No.: 17/906,347

(22) PCT Filed: Jun. 10, 2022
(86) PCT No.: PCT/JP2022/023419

§ 371 Date: Jan. 29, 2025

(51) Int. Cl. G06F 9/48; H04L 41/149

(52) U.S. Cl. CPC G06F 9/4881; G06F 9/485; H04L 41/149; G06F 2209/486

(57) ABSTRACT

A network management apparatus performs a determination process and a prioritization process. The determination process is processing that determines, while instructing to execute a first task registered in a first queue in sequence, whether or not an execution condition of a second task registered in a second queue, which has an execution priority higher than the first task, is satisfied. The prioritization process is processing that gives priority to instructing to execute the second task when the execution condition of the second task is satisfied.

### TECHNICAL FIELD

The present disclosure relates to priority control of tasks for network resources.

### BACKGROUND ART

With a background of improved performance of general-purpose servers and enhanced network infrastructures, cloud computing (hereinafter simply referred to as “cloud”), which on demand uses computing resources that are virtualized on physical resources such as servers, has become widely prevailing. In addition, the Network Function Virtualization (NFV), which virtualizes network functions and provides the virtualized network functions on the cloud, has been well known. The NFV is a technology that uses virtualization and cloud technologies to separate the hardware and software of various network services, which used to run on dedicated hardware, and to run the software on a virtualized infrastructure. It is expected to improve the sophistication of operations and reduce costs by use of those virtualization technologies.

In recent years, the virtualization has been advanced in mobile networks as well.

The European Telecommunications Standards Institute (ETSI) NFV defines the NFV architecture (see, for example, Patent Literature 1).

### LISTING OF REFERENCES

### Patent Literature

PATENT LITERATURE 1: International Publication of PCT International Patent Application No. WO2016/121802 A

### SUMMARY OF THE INVENTION

### Problems to be Solved by the Invention

Conventionally, in a large-scale network constructed on a virtualized infrastructure, administrators and operators have been performing construction operations and maintenance operations on network resources such as a NFVI (NFV Infrastructure) and a VNF (Virtual Network Function) via an OSS (Operation Support System).

In such a large-scale network, a large number of sites (e.g., data centers) are required to be constructed in a short period of time in order to respond to large-scale business demands in a short period of time. For this reason, in some cases, the construction processing needs to be performed at any time during the day or night. On the other hand, in the large-scale network, the maintenance and operation processing of the network may also occur at any time. Considering the impact on users, it is preferable to perform this maintenance and operation processing during late night hours when user's line utilization rate is relatively low.

However, if the construction processing keeps occupying processing resources of the OSS until late night hours, it will lead to failure in performing the maintenance and operation processing mentioned above, which may adversely affect network services.

Therefore, when a maintenance work is required, a person in charge of construction and another person in charge of maintenance need to coordinate their work time. However, relying on inter-organizational (or inter-personnel) coordination as mentioned above leads to bloated labor costs (or human resources). In addition, unless the construction work and maintenance work can be coordinated to be as seamless as possible, the processing resource efficiency of the OSS is likely to be deteriorated.

Therefore, the present disclosure addresses problems to improve resource efficiency when performing works such as construction, maintenance, and operation of a network.

### Solution to Problems

In order to solve the above mentioned problems, according to one aspect of the present disclosure, there is provided a network management apparatus comprising one or more processors and a storage device. The storage device stores a first queue in which a first task that is instructed to be executed in a predetermined sequence is registered, and a second queue in which a second task that has an execution priority higher than the first task is registered. At least one of the one or more processors performs a determination process and a prioritization process. The determination process is processing that determines whether or not an execution condition of the second task registered in the second queue is satisfied while instructing to execute the first task registered in the first queue in sequence. The prioritization process is processing that gives priority to instructing to execute the second task when the execution condition of the second task is determined to be satisfied.

In order to solve the above mentioned problems, according to another aspect of the present disclosure, there is provided a network management method comprising: determining, white instructing to execute a first task registered in a first queue in sequence, whether or not an execution condition of a second task registered in a second queue, which has an execution priority higher than the first task, is satisfied; and giving priority to instructing to execute the second task when the execution condition of the second task is determined to be satisfied.

In order to solve the above mentioned problems, according to yet another aspect of the present disclosure, there is provided a network management system comprising one or more processors and a storage device. The storage device stores a first queue in which a first task that is instructed to be executed in a predetermined sequence is registered, and a second queue in which a second task that has an execution priority higher than the first task is registered. At least one of the one or more processors performs a determination process and a prioritization process. The determination process is processing that determines whether or not an execution condition of the second task registered in the second queue is satisfied while instructing to execute the first task registered in the first queue in sequence. The prioritization process is processing that gives priority to instructing to execute the second task when the execution condition of the second task is determined to be satisfied.

### Advantageous Effect of the Invention

According to one aspect of the present disclosure, it makes it possible to improve resource efficiency when performing works such as construction, maintenance, and operation of a network.

### BRIEF DESCRIPTION OF DRAWINGS

FIG. 1 is a conceptual diagram illustrating an exemplary network configuration of a mobile network including a network management apparatus according to the present embodiment.

FIG. 2 is a block diagram illustrating an exemplary internal configuration of a network management system.

FIG. 3 is a block diagram illustrating an exemplary functional configuration of a priority controller section.

FIG. 4 is a sequence diagram illustrating an exemplary operation for registering normal tasks.

FIG. 5 is a sequence diagram illustrating an exemplary operation for registering priority tasks.

FIG. 6 is a flowchart illustrating an exemplary processing procedure of a task priority control operation.

FIG. 7 is a sequence diagram illustrating an exemplary operation for instructing to execute tasks.

FIG. 8 is a schematic diagram illustrating an example of registering normal tasks.

FIG. 9 is a schematic diagram illustrating an example of registering priority tasks.

FIG. 10 is a schematic diagram illustrating an example of priority control of tasks.

FIG. 11 is a schematic diagram illustrating an exemplary hardware configuration of the network management apparatus.

### DESCRIPTION OF EMBODIMENTS

Hereinafter, embodiments of the present invention will be described in detail with reference to the accompanying drawings. Among the constituent elements disclosed herein, those having the same function are denoted by the same reference numerals, and a description thereof is omitted. It should be noted that the embodiments disclosed herein are illustrative examples as means for implementing the present invention, and should be appropriately modified or changed depending on a configuration and various conditions of an apparatus to which the present invention is applied, and the present invention is not limited to the following embodiments. Furthermore, it should be noted that all of the combinations of features described in the following embodiments are not necessarily essential to the solution of the present invention.

Hereinafter, a non-limiting example will be described in which a network management apparatus according to the present embodiment has a priority control function that controls the priority of tasks for network resources. The present embodiment describes an exemplary case of the priority control of tasks in a mobile network constructed on a virtualized infrastructure.

More specifically, the network management apparatus is equipped with a storage unit (e.g., storage device) that stores a first queue in which a first task is registered and a second queue in which a second task is registered. Here, the first task is a task that is instructed to be executed in a predetermined sequence. The second task is a task that has an execution priority higher than the first task.

While instructing to execute the first task registered in the first queue in a predetermined sequence, the network management apparatus determines whether or not an execution condition of the second task registered in the second queue is satisfied. When the execution condition of the second task is determined to have been satisfied, the network management apparatus will prioritize the execution of the second task.

Hereinafter in the following description, the first task is referred to as a “normal task” and the second task is referred to as a “priority task”. Also, the first queue is referred to as a “normal queue” and the second queue is referred to as a “priority queue”.

The normal task and the priority task may include a task related to any one of construction, maintenance, and operation of a network, respectively. The normal task may be, for example, a task that has some degree of freedom in the execution date and time thereof, for example, a construction task to construct the network. On the other hand, the priority task may be a task with the fixed execution date and time, for example, a maintenance and operation task to maintain and operate the network. The maintenance and operation task is a task that may affect services and is defined to be executed during late night hours when user's line utilization rate is relatively low.

It should be noted that the normal task may include the maintenance and operation task, and the priority task may include the construction task.

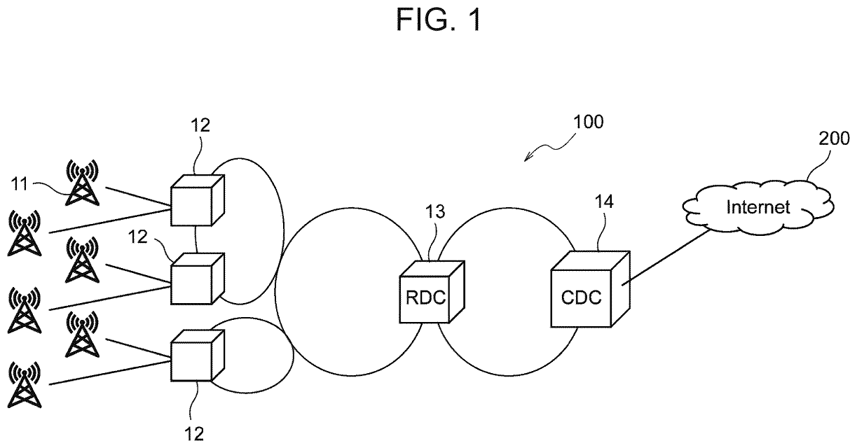

FIG. 1 is a conceptual diagram illustrating an exemplary network configuration of a mobile network 100 including a network management apparatus according to the present embodiment.

In the mobile network 100 shown in FIG. 1, a terminal capable of mobile communication such as a smartphone and the Radio Access Network (RAN) communicate with each other wirelessly, and the transmitted information is relayed through the backhaul network (i.e., Mobile Backhaul: MBH) to the core network for processing. This allows the mobile communication terminal to connect to the Internet 200 or connect to another company's network to make voice calls, or the like.

More specifically, the mobile network 100 includes base stations 11 and a plurality of accommodating stations 12 to 14. In FIG. 1, the accommodating station 12 is an edge data center, the accommodating station 13 is a Regional Data Center (RDC), and the accommodating station 14 is a Central Data Center (CDC). A backhaul network is constituted between the edge data center 12 and the central data center 14.

The mobile network 100 according to the present embodiment may be a virtualized network constructed on a virtualization infrastructure. The mobile network 100 realizes everything from the switching equipment of the backbone network to the radio access functions of the base stations by software on general-purpose servers.

The base station 11 is equipped with an antenna, a switchboard, a battery, and the like.

The edge data center 12 is located near the base stations 11 and is connected to a plurality of base stations 11 via fiber-optic cables, or the like. The edge data center 12 realizes the RAN-related radio access functions.

The regional data center 13 is connected to a plurality of edge data centers 12. The regional data center 13 realizes various applications by software, for the firewall/NAT (Network Address Translation), the CDN (Content Distribution Network), and edge computing.

The central data center 14 is connected to a plurality of regional data centers 13. The central data center 14 realizes core functions such as the EPC (Evolved Packet Core), the IMS (IP Multimedia Subsystem), or the like.

It should be noted that the number of respective data centers (i.e., accommodating stations), that is, the edge data center 12, the regional data center 13, and the central data center 14, is not limited to the number shown in FIG. 1. For example, although only one regional data center 13 and one central data center 14 are shown in FIG. 1, there may be a plurality of regional data centers 13 and central data centers 14, respectively.

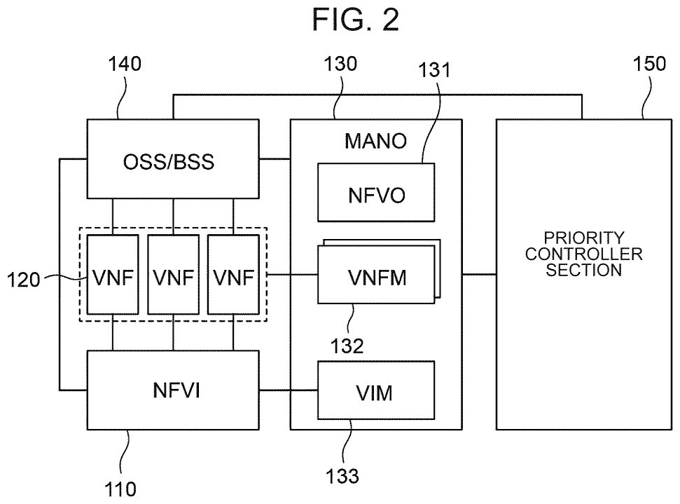

FIG. 2 is a block diagram illustrating an exemplary internal configuration of a network management system that constitutes the mobile network 100.

Each of constituent elements shown in FIG. 2 has a reference point. The lines connecting the constituent components shown in FIG. 2 indicate that connected constituent elements can send and receive information with each other.

The NFVI (NFV Infrastructure) 110 is a network function virtualization infrastructure, and includes physical resources, a virtualization layer, and virtualized resources. The physical resources include hardware resources such as computing resources, storage resources, and transmission resources. The virtualization layer is a virtualizing layer such as a hypervisor for virtualizing the physical resources and providing the virtualized physical resources to the VNF (Virtual Network Function) 120. The virtualized resources are the virtualized infrastructure resources provided to the VNF 120.

In other words, the NFVI 110 is an infrastructure that enables flexible handling of hardware resources of physical servers (hereinafter also simply referred to as “servers”), such as computing, storage, and network functions, and renders these hardware resources into virtualized hardware resources such as virtualized computing, virtualized storage, and virtualized network, which are virtualized by the virtualization layer such as the hypervisor.

A plurality of servers that constitute the NFVI 110 are grouped together and deployed in each of the data centers 12 to 14. The number, the placement positions, wiring, and the like, of the servers to be deployed in each of the data centers 12 to 14 are predetermined depending on the type of data center (i.e., accommodating station type). In each of the data centers 12 to 14, the deployed servers are connected by an internal network and are capable of sending and receiving information from each other. In addition, the data centers are connected to each other by a network, and the servers in different data centers are capable of sending and receiving information from each other via the network.

The VNF 120 corresponds to applications running on virtual machines (VMs) on the servers and implements the network functions by software. Although not specifically shown, each VNF 120 may be provided with a management function called an EM (Element Manager).

The NFVI 110 and the VNF 120 in FIG. 2 constitute the virtualized environment. In other words, the virtualized environment is constituted with three layers, in the bottom-up order namely: the hardware, the virtualization layer, and virtual machines.

The MANO (Management and Orchestration) 130 has management and orchestration functions for the virtualized environment. The MANO 130 includes the NFVO (NFV-Orchestrator) 131, the VNFM (VNF-Manager) 132, and the VIM (Virtualized Infrastructure Manager) 133.

The NFVO 131 orchestrates the NFVI resources, manages the lifecycle of network services, and provides integrated operational management of the entire system. The NFVO 131 is capable of performing processing in response to instructions from the OSS/BSS (Operation Support System/Business Support System) 140, which will be described below.

The VNFM 132 manages the lifecycle of each of the VNFs 120. It should be noted that the VNFM 132 may be arranged in the MANO 130 as a dedicated VNFM corresponding to each of the VNFs 120. Alternatively, a single VNFM 132 may manage the lifecycle of two or more VNFs 120. In this case, the VNFM 132 may be a general-purpose VNFM that supports VNFs 120 provided by different vendors.

The VIM 133 performs operational management of the resources used by the VNFs 120.

The OSS/BSS 140 is an integrated management system for the mobile network 100.

Here, the OSS is a system (i.e., equipment, software, mechanism, and the like) necessary for constructing and operating the desired services, and the BSS is an information system (i.e., equipment, software, mechanism, and the like) used for billing, invoicing, and customer services.

The priority controller section 150 realizes the priority control function that performs the priority control of tasks. The priority controller section 150 serves as the network management apparatus according to the present embodiment.

The priority controller section 150 instructs to execute the normal tasks, which are registered in the normal queue, in a predetermined sequence. Meanwhile, the priority controller section 150 determines whether or not the execution condition of the priority task registered in the priority queue is satisfied, and when the execution condition is determined to have been satisfied, the priority controller section 150 instructs to execute the priority task. In other words, the priority controller section 150 prioritizes to the execution condition of the priority task and gives priority to instructing to execute the priority task.

It should be noted that the priority controller section 150 is not limited to the case in which the priority controller section 150 is an external function of the OSS/BSS 140 or the MANO 130, as shown in FIG. 2. The priority controller section 150 may be provided inside the OSS/BSS 140 or the MANO 130. In this case, the priority control function of the priority controller section 150 becomes a part of the functions of the OSS/BSS 140 or the MANO 130.

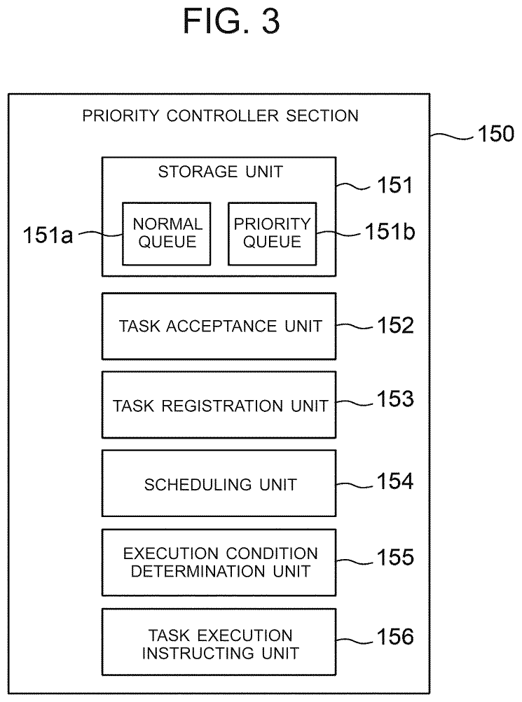

FIG. 3 is a block diagram illustrating an exemplary functional configuration of the priority controller section 150.

As shown in FIG. 3, the priority controller section 150 includes a storage unit 151, a task acceptance unit 152, a task registration unit 153, a scheduling unit 154, an execution condition determination unit 155, and a task execution instructing unit 156.

The storage unit 151 is equipped with a normal queue 151a and a priority queue 151b. The storage unit 151 may be either a memory or a storage device. Normal tasks are registered in the normal queue 151a, and priority tasks with execution priority higher than normal tasks are registered in the priority queue 151b.

It should be noted that the storage unit 151 may be equipped with multiple normal queues 151a and multiple priority queues 151b, respectively.

The task acceptance unit 152 accepts task information specified by a user. Here, the task information includes information related to the content of a task, information related to a node on which the task is to be executed, and task property information.

The content of the task may be, for example, a workflow that defines processes to be performed.

The node on which the task is to be executed may be, for example, servers or network devices (e.g., switches, routers, and the like) deployed in each of data centers 12 to 14.

The task property information includes information indicating the type of task and information indicating the execution condition of the task.

The information indicating the type of task may be, for example, a priority flag indicating whether or not the task concerned is the priority task. For example, when the priority flag indicates “true”, it indicates that the task concerned is the priority task.

The execution condition of the normal task includes at least a condition related to required time for a task concerned. The required time for the task is the estimated time required for processing the task, and may be set in units of, for example, one hour.

The execution condition for the priority task includes at least a condition related to the time zone to execute a task concerned. The time zone to execute a task may be set, for example, by the start date and time of the processing and the estimated end date and time.

The task registration unit 153 allocates tasks to either the normal queue 151a or the priority queue 151b to register the tasks therein based on the task information accepted by the task acceptance unit 152, and manages the task execution conditions.

More specifically, the task registration unit 153 checks the priority flag included in the task information accepted by the task acceptance unit 152, and when the priority flag, which indicates that the task concerned is a priority task, is appended to the task information, the task registration unit 153 determines the accepted task to be the priority task and registers the task concerned in the priority queue 151b. On the other hand, when the priority flag, which indicates that the task concerned is a priority task, is not appended to the task information, the task registration unit 153 determines the accepted task to be the normal task and registers the task concerned in the normal queue 151a.

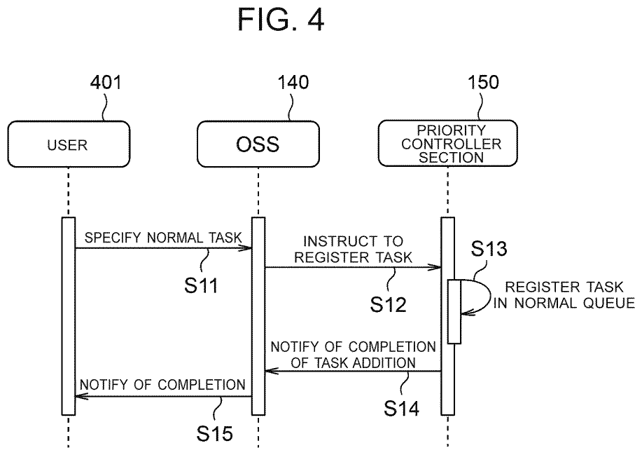

FIG. 4 is a sequence diagram illustrating an exemplary operation for registering normal tasks performed by the priority controller section 150.

First, in step S11, a user 401 specifies the task information for a normal task to the OSS 140. Here, the user 401 may be, for example, a person in charge of construction.

Upon receiving the task information from the user 401, in step S12, the OSS 140 sends an instruction to register the task to the priority controller section 150. At this time, the OSS 140 forwards the task information received from the user 401 to the priority controller section 150.

In step S13, the task acceptance unit 152 of the priority controller section 150 accepts the task information forwarded from the OSS 140. Subsequently, the task registration unit 153 checks the priority flag included in the task information. Since the task specified by the user 401 is a normal task, and thus either the priority flag is not appended to the task information or the priority flag indicates “false”, the task registration unit 153 registers the task concerned in the normal queue 151a. When the task registration is completed, in step S14, the priority controller section 150 sends a notification to notify of completion of task registration to the OSS 140.

Subsequently, in step S15, the OSS 140 forwards the notification to notify of completion of task registration to the user 401.

The execution priority and the order of execution of the normal tasks depend on the order in which the user 401 registers the normal tasks. In other words, multiple normal tasks are registered in the normal queue 151a in the order in which the normal tasks are registered by the user 401, and the multiple normal tasks registered in the normal queue 151a are executed in the same order as in which the normal tasks are registered by the user 401.

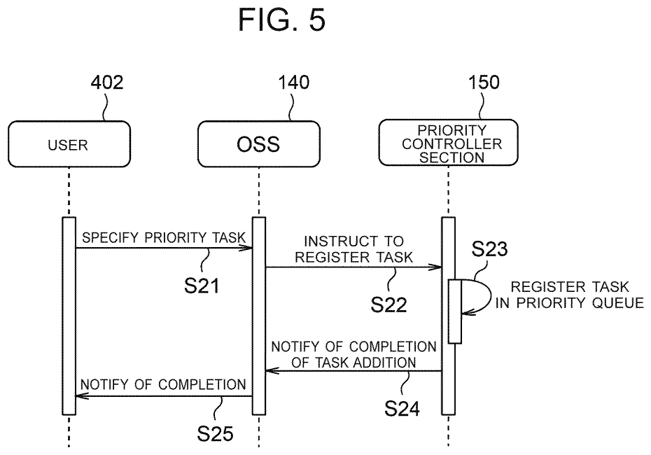

FIG. 5 is a sequence diagram illustrating an exemplary operation of registering priority tasks.

First, in step S21, a user 402 specifies the task information for a priority task to the OSS 140. Here, the user 402 may be, for example, a person in charge of maintenance and operation.

Upon receiving the task information from the user 402, in step 22, the OSS 140 sends an instruction to register the task to the priority controller section 150. At this time, the OSS 140 forwards the task information received from the user 402 to the priority controller section 150.

In step S23, the task acceptance unit 152 of the priority controller section 150 accepts the task information forwarded from the OSS 140. Subsequently, the task registration unit 153 checks the priority flag included in the task information. Since the task specified by the user 402 is a priority task and thus the priority flag indicates “true”, the task registration unit 153 registers the task concerned in the priority queue 151b. When the task registration is completed, in step S24, the priority controller section 150 sends a notification to notify of completion of task registration to the OSS 140.

Subsequently, in step S25, the OSS 140 forwards the notification to notify of completion of task registration to the user 402.

The execution priority and the order of execution of the priority tasks depend on the execution time zone, which is the property information of the task registered by the user 402.

Multiple priority tasks may be registered in the priority queue 151b. However, when the execution time zone of the priority task to be registered is earlier than the execution time zone of the priority task that has already been registered, the priority task to be registered is registered in a different priority queue 151b.

It is assumed that adjustment of execution priorities and execution time among multiple priority tasks are to be performed by the user 402.

Referring back to FIG. 3, the scheduling unit 154 schedules instructions to execute the normal tasks and the priority tasks, respectively, based on the execution conditions of the normal tasks and the priority tasks registered in the normal queue 151a and the priority queue 151b, respectively.

More specifically, the scheduling unit 154 schedules instructions to execute the priority tasks registered in the priority queue 151b such that the priority tasks are executed according to the execution conditions specified by a user. On the other hand, the scheduling unit 154 schedules instructions to execute the normal tasks registered in the normal queue 151a such that the normal tasks are executed in sequence, while avoiding the execution time zone of the priority tasks. Details of the scheduling of execution instructions for the normal tasks and the priority tasks will be described below.

The execution condition determination unit 155 determines whether or not the execution conditions of the tasks registered in each of queues 151a and 151b have been satisfied.

Assuming that the execution time zone is predetermined as an execution condition for a task, the execution condition determination unit 155 may determine that the execution condition for the task concerned is satisfied when the current time reaches the execution time zone for the task concerned, more specifically, when the current time equals the date and time to start the task concerned.

On the other hand, for a normal task for which the execution time zone is not predetermined as a task execution condition, the execution condition determination unit 155 may determine that the execution condition of the normal task concerned is satisfied when there is no such priority task as execution condition thereof has been satisfied.

The task execution instruction unit 156 instructs the OSS 140 to execute tasks that are determined the execution conditions have been satisfied by the execution condition determination unit 155. As a result, the OSS 140 retrieves the task that is instructed to be executed from the queue and executes the task with respect to the target node.

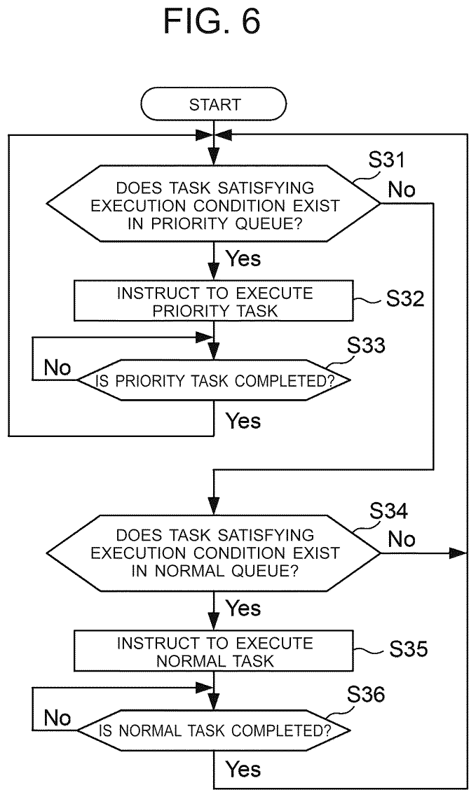

FIG. 6 is a flowchart illustrating an exemplary operation of the priority control of tasks.

In step S31, the execution condition determination unit 155 of the priority controller section 150 determines whether or not any priority task in the priority queue 151b of which execution condition has been satisfied. More specifically, the execution condition determination unit 155 determines among the priority tasks registered in the priority queue 151b whether or not any priority task of which processing start date and time matches the current date and time.

When the execution condition determination unit 155 determines that there exists such priority task as its processing start date and time matches the current date and time, the execution condition determination unit 155 determines that a priority task exists of which the execution condition has been satisfied and the processing proceeds to step S32. On the other hand, when the execution condition determination section 155 determines that there does not exist such priority task as its processing start date and time matches the current date and time, the execution condition determination unit 155 determines that there is no priority task of which the execution condition has been satisfied and the processing proceeds to step S34.

In step S32, the task execution instructing unit 156 sends to the OSS 140 an instruction to execute the priority task, the execution condition of which is determined to have been satisfied in step S31.

In step S33, the task execution instructing unit 156 determines whether or not the priority task instructed to be executed in step S32 is completed, and when the priority task concerned is not yet completed, the processing stands by until the priority task concerned is completed, and when the priority task concerned is completed, the processing returns to step S31.

In step S34, the execution condition determination unit 155 determines whether or not any normal task in the normal queue 151a of which execution condition has been satisfied. More specifically, the execution condition determination unit 155 determines whether or not the normal queue 151a contains any normal task of which processing start date and time matches the current date and time, or any normal task for which no task execution time zone is specified.

When the execution condition determination unit 155 determines that there exists such normal task as its processing start date and time matches the current date and time or such normal task as for which no task execution time zone is specified, the execution condition determination unit 155 determines that a normal task exists of which the execution condition has been satisfied and the processing proceeds to step S35. On the other hand, when the execution condition determination unit 155 determines that there does not exist such normal task as its processing start date and time matches the current date and time nor such normal task as for which a task execution time zone is specified, the execution condition determination unit 155 determines that there is no normal task of which the execution condition has been satisfied and the processing returns to step S31.

In step S35, the task execution instructing unit 156 sends to the OSS 140 the instruction to execute the normal task the execution condition of which is determined to have been satisfied in step S34.

In step S36, the task execution instructing unit 156 determines whether or not the normal task that is instructed to be executed in step S35 is completed or not, and when the normal task concerned is not completed, the processing stands by until the normal task concerned is completed, while when the normal task concerned is completed, the processing returns to step S31.

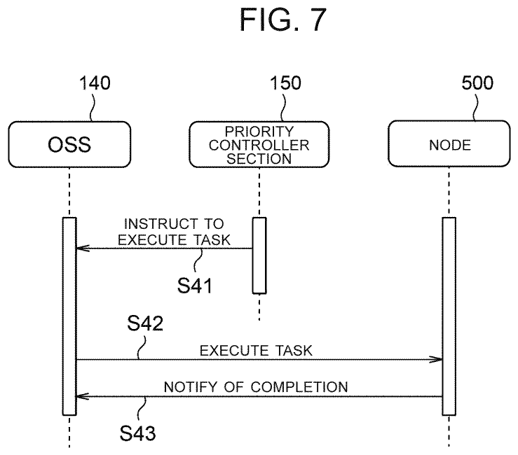

FIG. 7 is a sequence diagram illustrating an exemplary operation for instructing to execute tasks.

The priority controller section 150 sends an instruction to execute the task, as shown in step S41 in FIG. 7, to the OSS 140 in steps S32 and S35 in FIG. 6. This instruction to execute task includes the task information.

Upon receiving the instruction to execute the task, the OSS 140 executes the task with respect to the node 500, which is the target of the task execution, in step S42. Here, when the task that is instructed to be executed by the OSS 140 is a construction task, the construction processing is performed on the node 500. On the other hand, when the task that is instructed to be executed by the OSS 140 is a maintenance and operation task, the maintenance and operation processing is performed on the node 500.

Subsequently, when the task that is instructed to be executed is completed, in step S43, a completion notification is sent from the node 500 to the OSS 140.

Hereinafter, the task scheduling processing performed by the scheduling unit 154 will be described in detail.

In the mobile network 100, in order to construct a large number of sites (e.g., data centers) in a short period of time, the construction processing is required to be performed at any time throughout the day and night in some cases. On the other hand, in the mobile network 100, the processing for maintenance and operation of the network may also occur at any time. The construction processing and the maintenance and operation processing are all performed via the OSS 140, and therefore those processing times may conflict with each other.

For example, it is assumed that 100 sites (e.g., base locations) are scheduled to be constructed, and for the construction processing, the processing resources (such as CPUs and memories) on the OSS 140 side are required to be secured from 10:00 on a certain day to 5:00 on the following day. However, since the sites (i.e., base locations) to be constructed do not emit radio waves (in other words, do not provide services to users), the construction processing is not necessarily required to be completed by the end of a certain day. For this reason, a person in charge of construction registers a construction task that defines the above construction processing as a normal task.

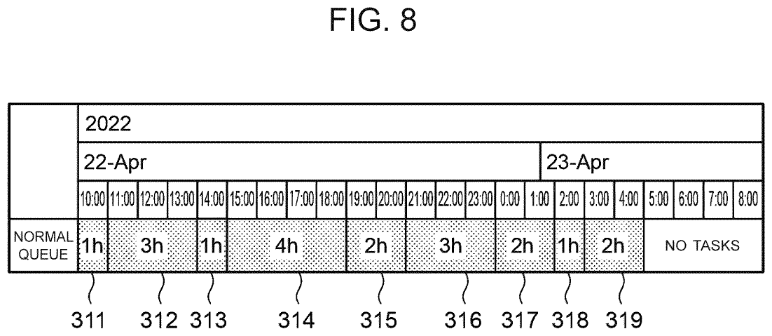

In this case, as shown in FIG. 8, the construction tasks 311 to 319, which are to be executed between 10:00 on a certain day (e.g., Apr. 22, 2022, in FIG. 8) to 5:00 on the following day, are registered in the normal queue 151a.

On the other hand, assuming that a failure occurs at a specific site on that day (or the day before that day), maintenance processing is required to be executed for the specific site. Since the specific site to be maintained emits radio waves (in other words, provides services to users), the maintenance processing concerned is required to be performed within the maintenance window in consideration of the impact on users. In addition, the maintenance processing is required to be completed expeditiously (i.e., within a certain day). It should be noted that the above maintenance window is generally allocated to late night hours (i.e., late night time zones) during which user's line utilization rate is relatively low, such as 22:00 on a certain day to 5:00 on the following day.

Under those circumstances, the maintenance processing has a higher priority than the construction processing. Therefore, a person in charge of maintenance registers the maintenance task that defines the above maintenance processing as a priority task.

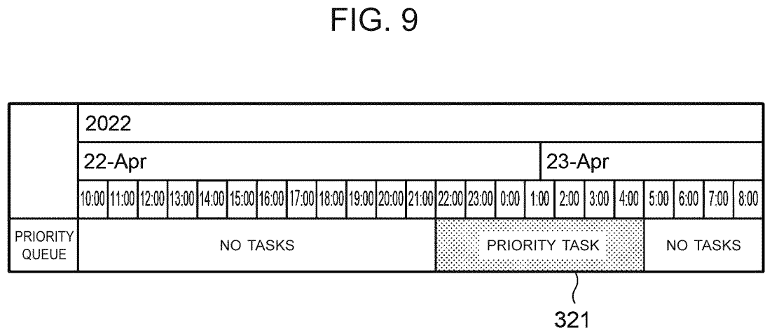

In this case, as shown in FIG. 9, the maintenance task 321, which is to be executed within the maintenance window on a certain day (e.g., Apr. 22, 2022, in FIG. 9), is registered in the priority queue 151b.

In the above mentioned situation, the scheduling unit 154 schedules instructions to execute tasks such that the construction tasks 311 to 319, which are the normal tasks, are executed while avoiding the execution time zone of the maintenance task 321, which is the priority task.

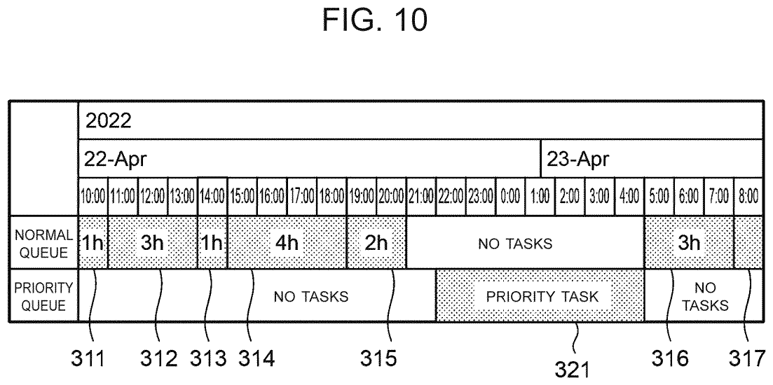

More specifically, as shown in FIG. 10, the scheduling unit 154 allocates the maintenance window (i.e., 22:00 to 5:00 on the following day) to the execution of the maintenance task 321 as it is, and allocates the time until the start date and time of the maintenance task 321 to the execution of the construction tasks 311 to 315 such that the construction tasks 311 to 315 are completed by the start date and time of the maintenance task 321. The scheduling unit 154 reallocates the time after the completion of the maintenance task 321 to the remaining construction tasks 316 to 319, the execution of which have previously been specified within the maintenance window. In other words, the execution conditions (i.e., execution time zones) of the construction tasks 316 to 319 are managed such that the time zones at or after 5:00 when the execution of the maintenance task 321 is completed are allocated to the construction tasks 316 to 319.

As shown in FIG. 8, when the execution time zone of the construction task 316 partially overlaps with the execution time zone of the priority task 321, the scheduling unit 154 may allocate the time from 21:00, the specified start time of the construction task 316, to 22:00, the specified start time of the priority task 321, to a time zone during which none of the tasks are executed. This is because, once the construction task 316 is scheduled to be executed from 21:00, the start of execution of the priority task 321 is likely to be delayed.

As described above, a gap time between the normal task and the priority task is permissible to be created. In this case, it makes it possible to give priority to the execution condition of the priority task to start execution of the priority task at the time specified by a user without failure.

As described above, the priority controller section 150, which serves as the network management apparatus according to the present embodiment, is equipped with the storage unit 151. The storage unit 151 stores the normal queue 151a, in which normal tasks that are instructed to be executed in a predetermined sequence are registered, and the priority queue 151b, in which priority tasks that have an execution priority higher than the normal tasks are registered. While the priority controller section 150 is giving instructions to execute multiple normal tasks registered in the normal queue 151a in sequence, the priority controller section 150 also determines whether or not the execution conditions of the priority tasks registered in the priority queue 151b are satisfied. If the execution condition of the priority task is determined to be satisfied, the priority controller section 150 gives priority to instructing to execute the priority task concerned.

Here, the normal task and the priority task may include a task related to any one of construction, maintenance, and operation of the network. For example, the normal task may include a construction task to construct the network, and the priority task may include a maintenance task to maintain and operate the network.

As described above, the priority controller section 150 according to the present embodiment is equipped with the storage unit 151 that stores multiple queues in which tasks with different priorities are registered, respectively, and controls to give priority to instructing the priority task to be executed. More specifically, when the execution condition of the priority task is determined to be satisfied while instructing to execute a series of normal tasks in sequence, the priority controller section 150 instructs to execute the priority task concerned at that timing.

In this way, it makes it possible to release in advance the processing resources for the priority task on the OSS 140 side, and also continue the execution of the normal tasks. As a result, it makes it possible to achieve the priority control of tasks related to the construction, maintenance and operation of the network as appropriate so as to improve the processing resource efficiency in the OSS 140 when executing the construction, maintenance and operation tasks of the network.

In addition, by controlling the priority of tasks, it makes it possible to eliminate the necessity of, for example, coordinating the execution time of tasks with different priorities among organizations (i.e., among persons in charge), thereby reducing labor costs.

Furthermore, priority tasks can be appropriately executed according to the specified execution conditions.

Here, the execution condition of the priority task may include the condition on the execution time zone of the priority task concerned. In this case, when the current time falls within the execution time zone for the priority task, for example, when the date and time to start the priority task arrives, the priority controller section 150 may determine that the execution condition of the priority task concerned is satisfied and instruct to execute the priority task concerned.

It should be noted that the execution condition of the priority task may include a condition on the execution order of the priority task concerned. The execution order of a task may be indicated, for example, by a numerical value with the highest priority being “1”. In this case, when the execution order of the priority task is set to be the highest priority, the priority controller section 150 may determine that the execution condition of the priority task concerned is satisfied and instruct to execute the priority task concerned.

In this way, even when there are constraints on the execution time zone or the execution order, it makes it possible to execute the priority task at the appropriate timing.

This prevents from happening such a situation where a task of higher priority registered later, for example, a maintenance task registered at the time of a failure, is held from being executed until all the normal tasks registered earlier have been completed. As a result, when a failure occurs, it makes it possible to give priority to executing the maintenance task to deal with the failure expeditiously so as to shorten the time period from the occurrence of the failure to recovery.

In addition, a person in charge of the maintenance no longer needs to stand by until all of the previously registered tasks are completed, thereby reducing the labor costs associated with the maintenance task.

Furthermore, the priority controller section 150 accepts specified input of the task type by a user, and registers the task in either the normal queue 151a or the priority queue 151b based on the information indicating the task type. In this way, the priority controller section 150 is able to register tasks to either the normal queue 151a or the priority queue 151b according to specified input by the user as appropriate.

In addition, the priority controller section 150 accepts specified input of the execution conditions of tasks by a user, and manages the execution conditions. More specifically, for normal tasks, the priority controller section 150 is able to manage the execution conditions including the time required for a normal task, and for priority tasks, manage the execution conditions including the execution time zone for a priority task. As a result, it makes it possible for the priority controller section 150 to perform the priority control of tasks as appropriate.

Yet furthermore, the priority controller section 150 may schedule an instruction to execute each task based on the execution condition of each task. In this case, it makes it possible to instruct to execute tasks more easily as appropriate based on the results of scheduling.

Also, the priority controller section 150 may schedule an instruction to execute each task such that multiple normal tasks are executed in sequence while avoiding the execution time zone of the priority task. Accordingly, it makes it possible to automatically adjust task scheduling such that normal tasks and priority tasks are executed as seamlessly as possible so as to improve the processing resource efficiency of the OSS 140 as appropriate.

Although the above embodiment describes an exemplary case in which the priority controller section 150 includes the scheduling unit 154 to schedule instructions to execute respective tasks. However, alternatively, the priority controller section 150 may be configured without the scheduling unit 154.

In this case, the execution condition determination unit 155 of the priority controller section 150 determines, when instructing to execute multiple normal tasks in sequence, whether or not to instruct to execute a normal task that is the next instruction target to be executed based on the execution conditions of the normal tasks and the priority tasks. More specifically, the execution condition determination unit 155 determines whether or not the execution time zone of the normal task that is the next instruction target to be executed overlaps with the execution time zone of the priority task registered in the priority queue 151b. When the above execution time zones are determined to overlap with each other, the execution condition determination unit 155 determines not to instruct to execute the normal task that is the next instruction target to be executed and suspends the instruction to execute the normal task concerned.

For example, as shown in FIG. 8, assuming that the construction tasks 311 to 319 are scheduled first, and subsequently the priority task 321 is allocated to the maintenance window as shown in FIG. 9, then the execution time zones for the construction tasks 316 to 319 and the execution time zone of the priority task 321 overlap with each other. In this case, the priority controller section 150 once suspends the instruction to execute the construction task 316 and, when the execution condition for the priority task 321 is satisfied, instructs to execute the priority task 321. Subsequently, when the execution of the priority task 321 is completed, the priority controller section 150 instructs to execute the construction task 316.

In this way, it makes it possible to achieve the same operation as when the task scheduling processing is performed by the scheduling unit 154 described above.

It should be noted that, when the priority task 321 is completed earlier than the scheduled completion time and date (i.e., 5:00), then it is possible to instruct to execute the construction task 316 ahead of schedule, which has been suspended from execution. In this case, it makes it possible to further improve the processing resource efficiency of the OSS 140.

As described above, according to the present embodiment, by setting priorities to tasks for network resources, such as network construction, maintenance and operation, to perform the priority control of tasks, it makes it possible to improve the processing resource efficiency of the OSS 140 and reduce labor costs.

The network management apparatus according to the present embodiment may be implemented in any of general-purpose servers that constitute the backhaul network, the core network, or the like, of the mobile network 100. Alternatively, the network management apparatus may be implemented in a dedicated server. The network management apparatus may also be implemented on a single or a plurality of computers.

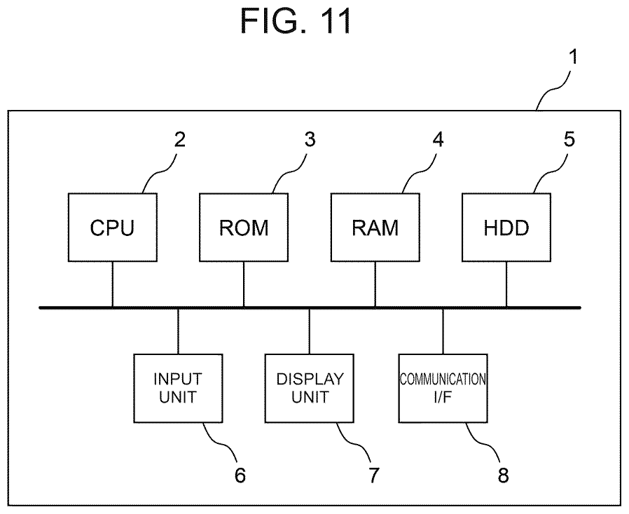

When the network management apparatus is implemented on a single computer, as shown in FIG. 11, the network management apparatus 1 may include a CPU 2, a ROM 3, a RAM 4, an HDD 5, an input unit (such as a keyboard, a pointing device) 6, a display unit (such as a monitor device) 7, a communication I/F 8, and the like. The network management apparatus 1 may further include an external memory.

The CPU (Central Processing Unit) 2 is constituted with one or more processors and controls entire operations of the network management apparatus 1 in a comprehensive manner. At least a part of functions of respective components of the priority controller section 150 shown in FIG. 3 may be implemented by the CPU 2 running programs. It should be noted that those programs may be stored in a non-volatile memory such as the ROM (Read Only Memory) 3, the HDD (Hard Disk Drive) 5, or the like, or alternatively, may be stored in the external memory such as a removable storage medium (not shown).

However, at least a part of the functions of the respective components of the priority controller section 150 shown in FIG. 3 may be operated by dedicated hardware. In this case, operation of the dedicated hardware is under the control of the CPU 2 described above.

For functions realized by hardware, for example, by using a prescribed compiler, for example, a dedicated circuit can be generated automatically on an FPGA from the programs to realize the functions of respective functional modules by using a predetermined compiler. Furthermore, a gate array circuit may be formed in the same way as the FPGA and realized as hardware, or alternatively, an ASIC (Application Specific Integrated Circuit) may be used.

Embodiments of the present disclosure may include a computer-readable storage medium that stores programs, and the programs may include instructions that, when being executed by the CPU 2 (e.g., at least one of the one or more processors) of the network management apparatus 1, causes the network management apparatus 1 to perform at least one of the methods described above.

Although exemplary embodiments have been described above, the embodiments described are merely illustrative and are not intended to limit the scope of the present invention. The apparatus and methods described herein may be embodied in other forms than those described above. In addition, without departing from the scope of the present invention, omissions, substitutions, and modifications may be made to the above embodiments as appropriate. Such omissions, substitutions, and modifications fall within the scope of the appended claims and equivalents thereof, and fall within the technical scope of the present invention.

The present disclosure includes the following embodiments.

[1] A network management apparatus, comprising: one or more processors; and a storage device configured to store a first queue in which a first task that is instructed to be executed in a predetermined sequence is registered, and a second queue in which a second task that has an execution priority higher than the first task is registered, at least one of the one or more processors being configured to perform: a determination process for determining whether or not an execution condition of the second task registered in the second queue is satisfied while instructing to execute the first task registered in the first queue in sequence; and a prioritization process for giving priority to instructing to execute the second task when the execution condition of the second task is determined to be satisfied.

[2] The network management apparatus according to [1], wherein the execution condition of the second task includes a condition related to a time zone to execute the second task, and the determination process determines that the execution condition of the second task is satisfied when current time reaches the time zone to execute the second task.

[3] The network management apparatus according to [1] or [2], at least one of the one or more processors further being configured to perform: an acceptance process for accepting task information, which is specified by a user, including information indicating a task type and information indicating the execution condition of the task; and a registration process for registering the task in either the first queue or the second queue based on the information indicating the task type included in the task information and managing the execution condition of the task.

[4] The network management apparatus according to any one of [1] to [3], at least one of the one or more processors further being configured to perform: a scheduling process for scheduling an instruction to execute the first task or the second task based on the execution condition of the first task and the second task.

[5] The network management apparatus according to [4], wherein the execution condition of the first task includes a condition related to required time for the first task, the execution condition of the second task includes a condition related to a time zone to execute the second task, and wherein the scheduling process schedules an instruction to execute the first task or the second task such that the first task is executed in sequence while avoiding the time zone to execute the second task.

[6] The network management apparatus according to any one of [1] to [3], at least one of the one or more processors further being configured to perform: a suspending process for determining, when instructing to execute the first task registered in the first queue in sequence, whether or not the time zone to execute the first task that is the next instruction target to be executed overlaps with the time zone to execute the second task registered in the second queue, and, when it is determined to overlap with each other, suspending the instruction to execute the first task that is the next instruction target to be executed.

[7] The network management apparatus according to any one of [1] to [6], wherein the first task and the second task include a task related to any one of construction, maintenance, and operation of a network, respectively.

[8] The network management apparatus according to [7], wherein the first task includes a construction task to construct the network, and the second task includes a maintenance and operation task to maintain and operate the network.

[9] A network management method, comprising: determining, while instructing to execute a first task registered in a first queue in sequence, whether or not an execution condition of a second task registered in a second queue, which has an execution priority higher than the first task, is satisfied; and giving priority to instructing to execute the second task when the execution condition of the second task is determined to be satisfied.

A network management system, comprising: one or more processors; and a storage device configured to store a first queue in which a first task that is instructed to be executed in a predetermined sequence is registered, and a second queue in which a second task that has an execution priority higher than the first task is registered, at least one of the one or more processors being configured to perform: a determination process for determining whether or not an execution condition of the second task registered in the second queue is satisfied while instructing to execute the first task registered in the first queue in sequence; and a prioritization process for giving priority to instructing to execute the second task when the execution condition of the second task is determined to be satisfied.

### REFERENCE SIGNS LIST

11: Base Station; 12: Edge Data Center; 13: Regional Data Center; 14: Central Data Center; 100: Mobile Network; 110: NFVI; 120: VNF; 130: MANO; 131: NFVO; 132: VNFM; 133: VIM; 140: OSS/BSS; 150: Priority Controller Section; 151: Storage Unit; 151a: Normal Queue (First Queue); 151b: Priority Queue (Second Queue); 152: Task Acceptance Unit; 153: Task Registration Unit; 154: Scheduling Unit; 155: Execution Condition Determination Unit; 156: Task Execution Instructing Unit

What is claimed is:

1. A network management apparatus, comprising:
one or more processors; and a storage device configured to store a first queue in which a first task that is instructed to be executed in a predetermined sequence is registered, and a second queue in which a second task that has an execution priority higher than the first task is registered, at least one of the one or more processors being configured to perform:
a determination process for determining whether or not an execution condition of the second task registered in the second queue is satisfied while instructing to execute the first task registered in the first queue in sequence; and
a prioritization process for giving priority to instructing to execute the second task when the execution condition of the second task is determined to be satisfied.

2. The network management apparatus according to claim 1, wherein
the execution condition of the second task includes a condition related to a time zone to execute the second task, and
the determination process determines that the execution condition of the second task is satisfied when current time reaches the time zone to execute the second task.

3. The network management apparatus according to claim 1, at least one of the one or more processors further being configured to perform:
an acceptance process for accepting task information, which is specified by a user, including information indicating a task type and information indicating the execution condition of the task; and
a registration process for registering the task in either the first queue or the second queue based on the information indicating the task type included in the task information and managing the execution condition of the task.

4. The network management apparatus according to claim 1, at least one of the one or more processors further being configured to perform:
a scheduling process for scheduling an instruction to execute the first task or the second task based on the execution condition of the first task and the second task.

5. The network management apparatus according to claim 4, wherein
the execution condition of the first task includes a condition related to required time for the first task,
the execution condition of the second task includes a condition related to a time zone to execute the second task, and wherein
the scheduling process schedules an instruction to execute the first task or the second task such that the first task is executed in sequence while avoiding the time zone to execute the second task.

6. The network management apparatus according to claim 1, at least one of the one or more processors further being configured to perform:
a suspending process for determining, when instructing to execute the first task registered in the first queue in sequence, whether or not the time zone to execute the first task that is the next instruction target to be executed overlaps with the time zone to execute the second task registered in the second queue, and, when it is determined to overlap with each other, suspending the instruction to execute the first task that is the next instruction target to be executed.

7. The network management apparatus according to claim 1, wherein
the first task and the second task include a task related to any one of construction, maintenance, and operation of a network, respectively.

8. The network management apparatus according to claim 7, wherein
the first task includes a construction task to construct the network, and
the second task includes a maintenance and operation task to maintain and operate the network.

9. A network management method, comprising:
determining, while instructing to execute a first task registered in a first queue in sequence, whether or not an execution condition of a second task registered in a second queue, which has an execution priority higher than the first task, is satisfied; and
giving priority to instructing to execute the second task when the execution condition of the second task is determined to be satisfied.

10. A network management system, comprising:
one or more processors; and a storage device configured to store a first queue in which a first task that is instructed to be executed in a predetermined sequence is registered, and a second queue in which a second task that has an execution priority higher than the first task is registered, at least one of the one or more processors being configured to perform:
a determination process for determining whether or not an execution condition of the second task registered in the second queue is satisfied while instructing to execute the first task registered in the first queue in sequence; and
a prioritization process for giving priority to instructing to execute the second task when the execution condition of the second task is determined to be satisfied.
